(19) United States
(12) Patent Application Publication
(10) Pub. No.: US 2008/0095531 A1
(43) Pub. Date: Apr. 24, 2008

(54) DEVICE AND METHOD FOR INSPECTING OPTICAL MODULATOR

(75) Inventors: In-Jae Yeo, Yongin-si (KR); Sang-Kyeong Yun, Suwon-si (KR); Seung-Do An, Suwon-si (KR); Kyu-Bum Han, Yongin-si (KR); Jong-Hyeong Song, Suwon-si (KR); Yoon-Shik Hong, Seongnam-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/863,096

(22) Filed: Sep. 27, 2007

(30) Foreign Application Priority Data
Oct. 2, 2006 (KR) 1020060097303

(51) Int. Cl. H04B 10/08

(52) U.S. Cl. 398/9

(57) ABSTRACT

An aspect of the present invention provides a device for inspecting an optical modulator. The device can comprise: a probe card that converts an inputted control signal to a driving signal, and provide the driving signal by contacting with each driving signal input pad of an optical modulator—wherein the optical modulator comprises one or more micromirrors and one or more driving signal input pads connected to the micromirrors, respectively, and the micromirror moves up and down according to the driving signal inputted through the driving signal input pad—; and an image control circuit that generates the control signal for checking if the optical modulator is operation properly, and is connected electrically to the probe card to transmit the control signal. A device and a method for inspecting an optical modulator according to the present invention can inspect performance and function of the optical modulator at a chip level.

### CROSS-REFERENCE TO RELATED APPLICATIONS

This application claims the benefit of Korean Patent Application No. 10-2006-0097303 filed with the Korean Intellectual Property Office on Oct. 2, 2006, the disclosures of which are incorporated herein by reference in their entirety.

### BACKGROUND

1. Technical Field

The present invention relates to an optical modulator, more particularly to a device and a method for determining whether or not a chip type of an optical modulator is operating properly.

2. Description of the Related Art

With the development of display technology, a demand for displaying on a large screen apparatuses has increased day by day.

Most of current large screen display apparatuses (mainly projectors) use a liquid crystal as an optical switch since a liquid crystal projector is small, inexpensive and composed of a simple optical system compared to the conventional cathode-ray tube (CRT) projector.

But, since light is projected on a screen through a liquid crystal plate from a light source, it causes a lot of optical loss. In order to obtain a brighter image, a micromachine such as an optical modulator, which uses reflection, can be applied to reduce the optical loss.

The micromachine refers to a machine which is so miniaturized as to be invisible with naked eyes. That can be also called a micro electro mechanical system (MEMS), and is manufactured by using semiconductor manufacturing technology.

These micromachines are applied to a many kinds of information devices such as a magnetic and optical head by using a micro optics and a nano device, and are also applied to a biomedical field and a semiconductor manufacturing process by using various micro fluid control technologies.

The micromachine can be classified into a micro sensor, a micro actuator and a miniature machine depending on its function.

The MEMS is applied to the optical science field as one of its applications. Using micromachining technology, optical components smaller than 1 mm can be fabricated, by which micro optical systems can be implemented.

Micro optical systems including an optical modulator element, a micro lens and the like have been are currently selected and applied in telecommunication devices and information display and recording devices, due to such advantages as quick response time, low level of loss, and convenience in layering and digitalizing.

An optical modulator, which is used for a scanning display apparatus, is manufactured by using a semiconductor manufacturing technology, a wafer fabrication process.

The optical modulator is inspected for its performance and function when a manufacturing process is completed, only good products are inputted into a next process for fabricating a display apparatus. But, there is no a device or method for determining whether or not the optical modulator implemented in a chip is operating properly.

### SUMMARY

The present invention provides a device and a method for inspecting an optical modulator that can inspect performance and function of the optical modulator at a chip level.

And, the present invention provides a device and a method for inspecting an optical modulator that can prevent an inferior optical modulator to be delivered to a next process such as optical modulator packaging, display apparatus manufacturing, etc., thereby reducing greatly the manufacturing expenses.

An aspect of the present invention provides a device for inspecting an optical modulator. The device can comprise: a probe card that converts an inputted control signal to a driving signal, and provide the driving signal by contacting with each driving signal input pad of an optical modulator—wherein the optical modulator comprises one or more micromirrors and one or more driving signal input pads connected to the micromirrors, respectively, and the micromirror moves up and down according to the driving signal inputted through the driving signal input pad—; and an image control circuit that generates the control signal for checking if the optical modulator is operation properly, and is connected electrically to the probe card to transmit the control signal.

The probe card can comprise: a substrate where a probe hall, a first wire through which the control signal is transmitted, and a second wire through which the driving signal is transmitted are formed; a driver IC that is connected electrically to the first and the second wires, converts the control signal, which is inputted through the first wire, to the driving signal, and then outputs the driving signal through the second wire; and one or more probes of which one end is connected electrically to the second wire and fixed on the substrate, and the other end is extended in the direction where the optical modulator will be located, so that the probe can be contacted with the driving signal input pad, wherein the number of the probe is the same as that of the driving signal input pad.

The driver IC can be formed on one side of the substrate and the optical modulator can be formed on the other side, the other end of the probe can be exposed to the other side of the substrate through the probe hall.

The device can further comprise: a light source that irradiates light to the optical modulator; a stage that supports the optical modulator such that the light is irradiated onto the micromirror; a sensor that detects light modulated and outputted by the optical modulator; and a measuring device that measures luminance of the light detected by the sensor.

The device can further comprise a slit that allows only diffracted light of a predetermined-order in the light modulated and outputted by the optical modulator to pass and be inputted to the sensor.

The stage can move horizontally and vertically, and let the optical modulator be arranged on the center of the probe hall such that the probe is contacted with the driving signal input pad.

The probe card can move horizontally and vertically, and let the optical modulator be arranged on the center of the probe hall such that the probe is contacted with the driving signal input pad.

The device can further comprise a detector that determines whether or not the optical modulator is operating properly by comparing luminance of the light measured by the measuring device and ideal luminance corresponding to the control signal of the image control circuit.

The detector determines whether or not each micromirror of the optical modulator is operating properly

Another aspect of the present invention provides a method for inspecting an optical modulator. The method can comprise: holding an optical modulator on a stage; moving the stage horizontally and vertically to arrange the optical modulator on the center of a probe hall, and allow a probe to contact with a driving signal input pad; transmitting a control signal from an image control circuit to the probe card; converting the control signal to a driving signal in the probe card; and providing the control signal to the optical modulator through the probe.

The method can further comprise: detecting light modulated by the optical modulator; comparing luminance of the detected light and ideal luminance corresponding to the control signal; and determining whether or not the optical modulator is operating properly, depending on the result of comparing. The determination can be performed separately for each micromirror of the optical modulator.

The detecting of light can be a detection only of diffracted light of a predetermined-order in the light modulated by the optical modulator.

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1a is a perspective view of a micromirror of an optical modulator using a piezoelectric element applicable to an embodiment of the invention.

FIG. 1b is a perspective view of a micromirror of another optical modulator using a piezoelectric element applicable to an embodiment of the invention.

FIG. 1c is a plan view of an optical modulator containing a plurality of micromirrors illustrated in FIG. 1a.

FIG. 1d is a schematic diagram illustrating an image generated on a screen by means of a diffraction type optical modulator array applicable to an embodiment of the invention.

FIG. 2 illustrates a configuration of a display apparatus composed of an optical modulator according to an embodiment of the present invention.

FIG. 3 illustrates a configuration connecting an optical modulator and a driver IC according to an embodiment of the present invention.

FIG. 4 illustrates a configuration of a device for inspecting the driving performance of an optical modulator according to an embodiment of the present invention.

FIG. 5 is a sectional view of a probe card according to an embodiment of the present invention.

FIG. 6 is a sectional view of a probe card according to another embodiment of the present invention.

FIG. 7 is a sectional view of a probe card according to another embodiment of the present invention.

FIG. 8 is a configuration of a device for inspecting an optical modulator according to an embodiment of the present invention.

FIG. 9 is a sectional view of FIG. 8.

FIG. 10 is a flowchart of a method for inspecting an optical modulator according to an embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

An optical modulator applied to the present invention will first be described before discussing embodiments of the present invention.

The optical modulator is mainly divided into a direct type, which directly controls the on/off state of light, and an indirect type, which uses reflection and diffraction. The indirect type may be further divided into an electrostatic type and a piezoelectric type. The optical modulators are applicable to the embodiments of the invention regardless of the operation type.

An electrostatic type grating optical modulator as disclosed in U.S. Pat. No. 5,311,360 includes a plurality of equally spaced deformable reflective ribbons having reflective surfaces and suspended above an upper part of the substrate.

First, an insulation layer is deposited onto a silicon substrate, followed by depositions of a sacrificial silicon dioxide film and a silicon nitride film. The silicon nitride film is patterned with the ribbons, and some portions of the silicon dioxide film are etched so that the ribbons are maintained by a nitride frame on an oxide spacer layer.

The grating amplitude, of such a modulator limited to the vertical distance d between the reflective surfaces of the ribbons and the reflective surface of the substrate, is controlled by supplying a voltage between the ribbons (the reflective surface of the ribbon, which acts as a first electrode) and the substrate (the conductive film at the bottom portion of the substrate, which acts as a second electrode).

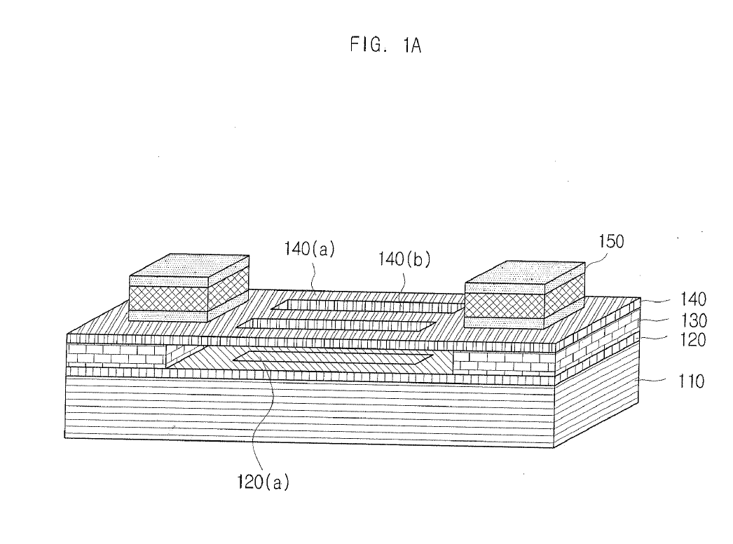

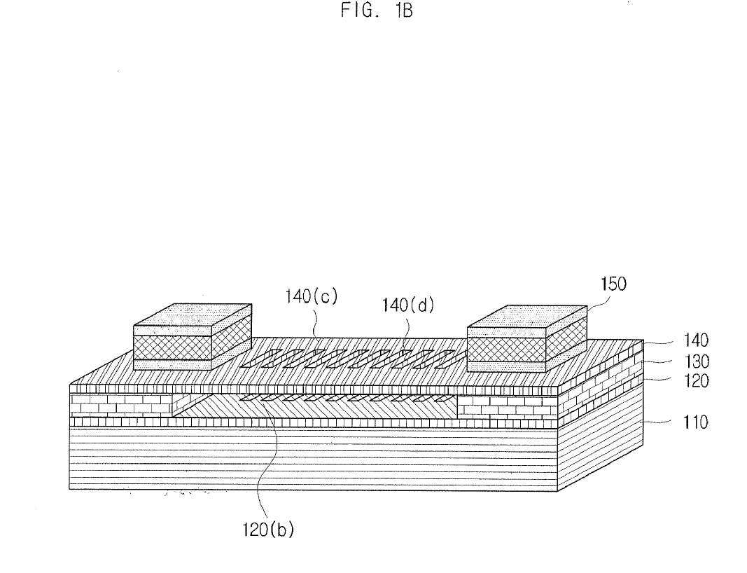

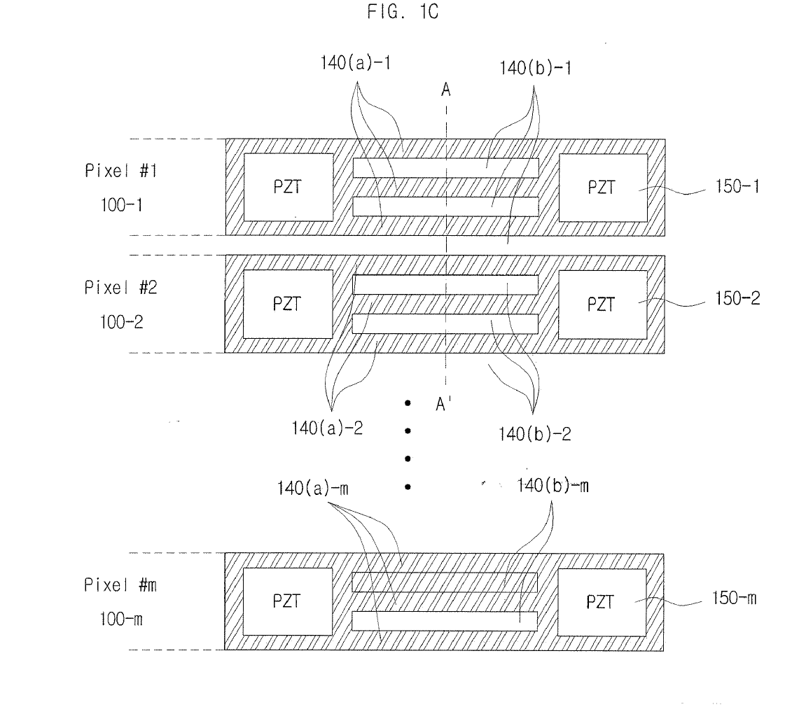

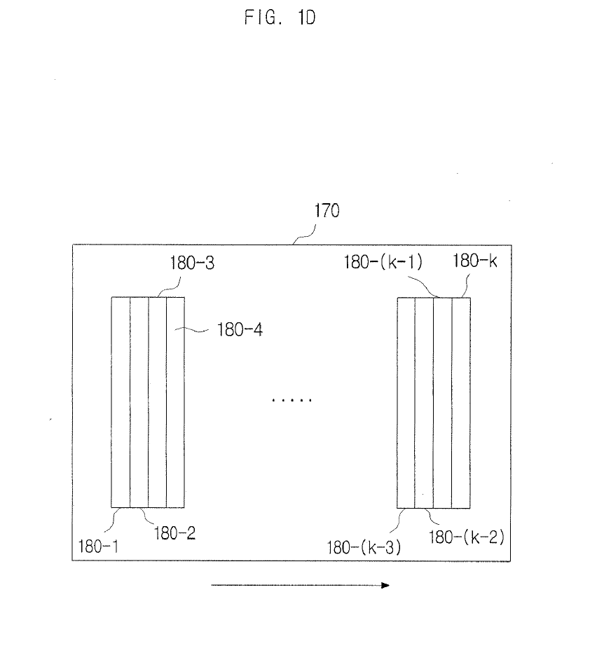

FIG. 1a is a perspective view of a micromirror of an optical modulator using a piezoelectric element applicable to an embodiment of the invention, and FIG. 1b is a perspective view of a micromirror of another optical modulator using a piezoelectric element applicable to an embodiment of the invention. Referring to FIGS. 1a and 1b, an optical modulator is illustrated which comprises a substrate 110, an insulation layer 120, a sacrificial layer 130, a ribbon structure 140, and piezoelectric elements 150.

The substrate 110 is a generally used semiconductor substrate, while the insulation layer 120 is deposited as an etch stop layer and is formed from a material with a high selectivity to the etchant (the etchant is an etchant gas or an etchant solution) that etches the material used for the sacrificial layer. Here, a reflective layer 120a, 120b may be formed on the insulation layer 120 to reflect incident beams of light.

The sacrificial layer 130 supports the ribbon structure 140 from both sides, such that the ribbon structure 140 may be spaced by a constant gap from the insulation layer 120, and forms a space in the center.

The ribbon structure 140 creates diffraction and interference in the incident light to provide optical modulation of signals as described above. The ribbon structure 140 may be composed of a plurality of ribbon shapes according to the electrostatic type, or may comprise a plurality of open holes 140(b), 140(d) in the center portion of the ribbons according to the piezoelectric type. The piezoelectric elements 150 control the ribbon structure 140 to move vertically, according to the degree of up/down or left/right contraction or expansion generated by the difference in voltage between the upper and lower electrodes. Here, the reflective layers 120(a), 120(b) are formed in correspondence with the holes 140(b), 140(d) formed in the ribbon structure 140.

For example, in the case where the wavelength of a beam of light is λ, when there is no power supplied or when there is a predetermined amount of power supplied, the gap between an upper reflective layer 140(a), 140(c) formed on the ribbon structure and the insulation layer 120, on which is formed a lower reflective layer 120(a), 120(b), is equal to (2n)λ/4 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the lower reflective layer 120(a), 120(b) is equal to nλ, so that constructive interference occurs and the diffracted light is rendered its maximum luminosity. In the case of +1 or −1 order diffracted light, however, the luminosity of the light is at its minimum value due to destructive interference.

Also, when an appropriate amount of power is supplied to the piezoelectric elements 150, other than the supplied power mentioned above, the gap between the upper reflective layer 140(a), 140(c) formed on the ribbon structure and the insulation layer 120, on which is formed the lower reflective layer 120(a), 120(b), becomes (2n+1)λ/4 (wherein n is a natural number). Therefore, in the case of a 0-order diffracted (reflected) beam of light, the overall path length difference between the light reflected by the upper reflective layer 140(a), 140(c) formed on the ribbon structure and the light reflected by the insulation layer 120 is equal to (2n+1)λ/2, so that destructive interference occurs, and the diffracted light is rendered its minimum luminosity. In the case of +1 or −1 order diffracted light, however, the luminosity of the light is at its maximum value due to constructive interference. As a result of such interference, the optical modulator can load signals on the beams of light by controlling the quantity of the reflected or diffracted light.

While the foregoing describes the cases in which the gap between the ribbon structure 240 and the insulation layer 120, on which is formed the lower reflective layer 120(a), 120(b), is (2n)λ/4 or (2n+1)λ/4, it is obvious that a variety of embodiments may be applied with regards the present invention which are operated with gaps that allow the control of the interference by diffraction and reflection.

The descriptions below will focus on the type of micromirror illustrated in FIG. 1a described above.

And, 0-order diffracted (reflected) light, +n order diffracted light, and −n order diffracted light (wherein n is a natural number) will all be referred to as modulated light.

FIG. 1c is a plan view of an optical modulator containing a plurality of micromirrors illustrated in FIG. 1a.

Referring to FIG. 1c, the optical modulator is composed of an m number of micromirrors 100-1, 100-2, . . . , 100-m, each responsible for pixel #1, pixel #2, . . . , pixel #m. The optical modulator deals with image information with respect to 1-dimensional images of vertical or horizontal scanning lines (Here, it is assumed that a vertical or horizontal scanning line consists of an m number of pixels.), while each micromirror 100-1, 100-2, . . . , 100-m deals with one pixel among the m pixels constituting the vertical or horizontal scanning line.

Thus, the light reflected and diffracted by each micromirror is later projected by an optical scanning device as a 2-dimensional image on a screen. For example, in the case of VGA 640*480 resolution, modulation is performed 640 times on one surface of an optical scanning device (not shown) for 480 vertical pixels, to generate 1 frame of display per surface of the optical scanning device. Here, the optical scanning device may be a polygon mirror, a rotating bar, or a galvano mirror, etc.

While the description below of the principle of optical modulation concentrates on pixel #1, the same may obviously apply to other pixels.

In the present embodiment, it is assumed that the number of holes 140(b)-1 formed in the ribbon structure 140 is two. Because of the two holes 140(b)-1, there are three upper reflective layers 140(a)-1 formed on the upper portion of the ribbon structure 140. On the insulation layer 120, two lower reflective layers are formed in correspondence with the two holes 140(b)-1. Also, there is another lower reflective layer formed on the insulation layer 120 in correspondence with the gap between pixel #1 and pixel #2.

Thus, there are an equal number of upper reflective layers 140(a)-1 and lower reflective layers per pixel, and as discussed with reference to FIG. 1a, it is possible to control the luminosity of the modulated light using 0-order diffracted light or ±1-order diffracted light.

FIG. 1d is a schematic diagram illustrating an image generated on a screen by means of a diffraction type optical modulator array applicable to an embodiment of the invention.

Illustrated is a display 180-1, 180-2, 180-3, 180-4, . . . , 180-(k−3), 180-(k−2), 180-(k−1), 180-k generated when beams of light reflected and diffracted by an m number of vertically arranged micromirrors 100-1, 100-2, . . . , 100-m are reflected by the optical scanning device and scanned horizontally onto a screen 170. One image frame may be projected with one revolution of the optical scanning device. Here, although the scanning direction is illustrated as being from left to right (the direction of the arrow), it is apparent that images may be scanned in other directions (e.g. in the opposite direction).

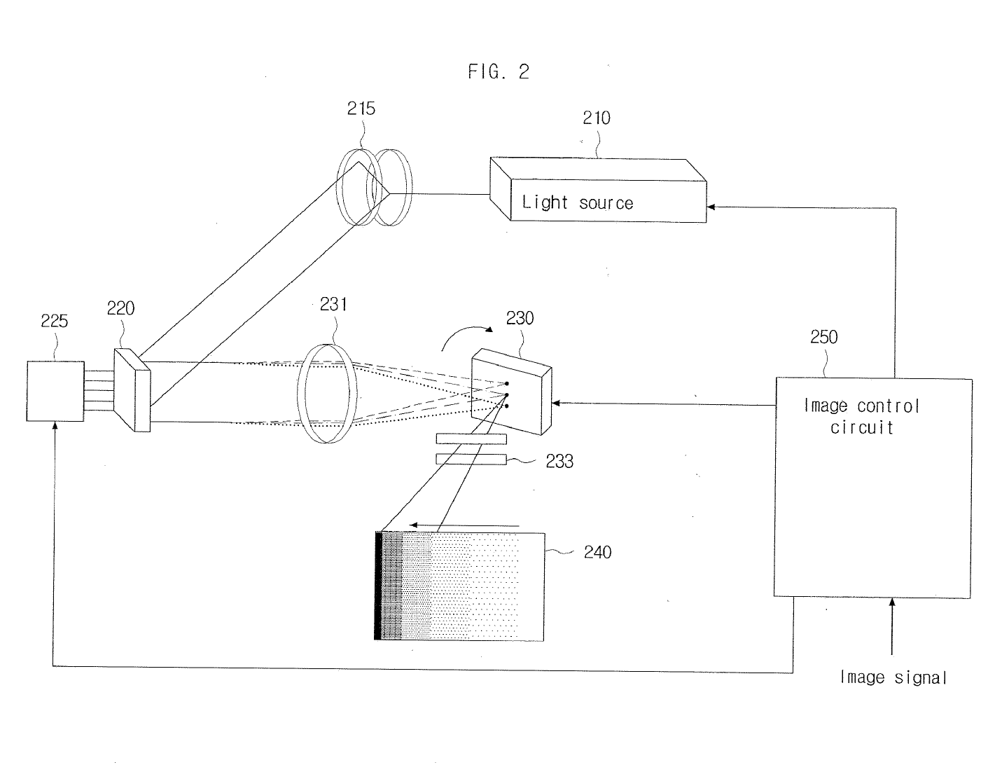

FIG. 2 illustrates a configuration of a display apparatus composed of an optical modulator according to an embodiment of the present invention.

The display apparatus includes a light source 210, an optical modulator 220, a driver integrated circuit (IC) 225, a scanner 230, and an image control circuit 250.

The light source 210 emits light so that an image can be projected on a screen 240. The light source 210 can emit light with white or one of the three primary colors, red, green, and blue. The light source 210 can be a laser, a light emitting diode (LED), or a laser diode. Here, the white light is separated into the red, green, and blue lights depending on a condition by a color separating unit (not shown).

And, an illumination optical system 215 is equipped between the light source 210 and the optical modulator 220, and can reflect the light emitted from the light source 210 by a designated angle to focus the light onto the optical modulator 220.

When the light is separated by the color separation unit (not shown), a separate function of focusing the light can be possessed in the illumination optical system 215.

The optical modulator 220 modulates the light emitted from the light source 210 in accordance with driving voltage, which is supplied by the driver IC 225, and outputs the modulated light.

The optical modulator 220 is described above by referring to FIGS. 1a through 1d, thus, here is omitted the detailed description of it.

The optical modulator 220 is composed of a plurality of micromirrors arrayed in a row, and deals with the one-dimensional images of the vertical or horizontal scanning line in a frame image.

In more detail, the optical modulator 220 outputs modulated light of which brightness is modulated by changing displacement of a micromirror corresponding to each pixel of the one-dimensional image, according to the driving voltage.

The number of the micromirrors may be as many as the pixels composing the vertical or horizontal scanning line.

The modulated light refers to light in which image information of the vertical or horizontal scanning line (that is, a brightness value of each pixel composing the vertical or horizontal scanning line) to be projected later on the screen 240 is reflected, and can be the 0-order diffracted (reflected) light, +n order diffracted light, or −n order diffracted light (wherein n is a natural number).

The driver IC 225 supplies the driving voltage to the optical modulator 220 in order to change the brightness of the modulated light according to image control signals, which is outputted from the image control circuit 250.

A relay optical system 231 transmits the modulated light outputted by the optical modulator 220 to the scanner 230. The relay optical system 231 can include one or more lenses, and controls the modulated light to be appropriate to sizes of the optical modulator 220 and the scanner 230 through adjusting a magnification of the lens, if needed.

The scanner 230 reflects the modulated light, which is inputted from the optical modulator 220, by a designated angle, and then projects that light to the screen 240. Here, the angle is determined by a scanner control signal inputted from the image control circuit 250.

The scanner control signal is synchronized with the image control signal to turn the scanner 230 with an angle such as the modulated light can be projected onto a position corresponding to the image control signal in the vertical or horizontal scanning line on the screen 240. Examples of the scanner 230 can include a polygon mirror, rotating bar, galvano meter, etc.

The modulated light from the optical modulator 220 can be the 0-order diffracted light, +n order diffracted light, or −n order diffracted light. Each diffracted light is projected on the screen 240 by the scanner 230. In this case, a slit 233 is equipped to select diffracted light of a desired order and project it on the screen 240 since each diffracted light is progressed in a different course.

A projection optical system (not shown) is located between the relay optical system 231 and the scanner 230, allowing the modulated light from the optical modulator 220 to be projected to the scanner 230, and includes a projection lens (not shown). Or, the projection optical system can be located between the scanner 230 and the screen 240, allowing the modulated light reflected by the scanner 230 to be projected on the screen 240.

The image control circuit 250 sends image control signals, scanner control signals, and light source control signals to the driver IC 225, the scanner 230, and the light source 210, respectively.

That is, the image control circuit 250 receives image signals of a frame, and interlocks the image control signal, the scanner control signal, and the light source control signal in accordance with the image signals to control the light source 210, the optical modulator 220, and the scanner 230, thereby displaying the frame image on the screen 240.

In more detail, the image control circuit 250 sends to the driver IC 225 the image control signal corresponding to brightness information for each pixel composing the frame, and controls a rotational angle or a rotational speed of the scanner 230 depending on the image control signal, thereby projecting the vertical or horizontal scanning line to a predetermined portion on the screen 240.

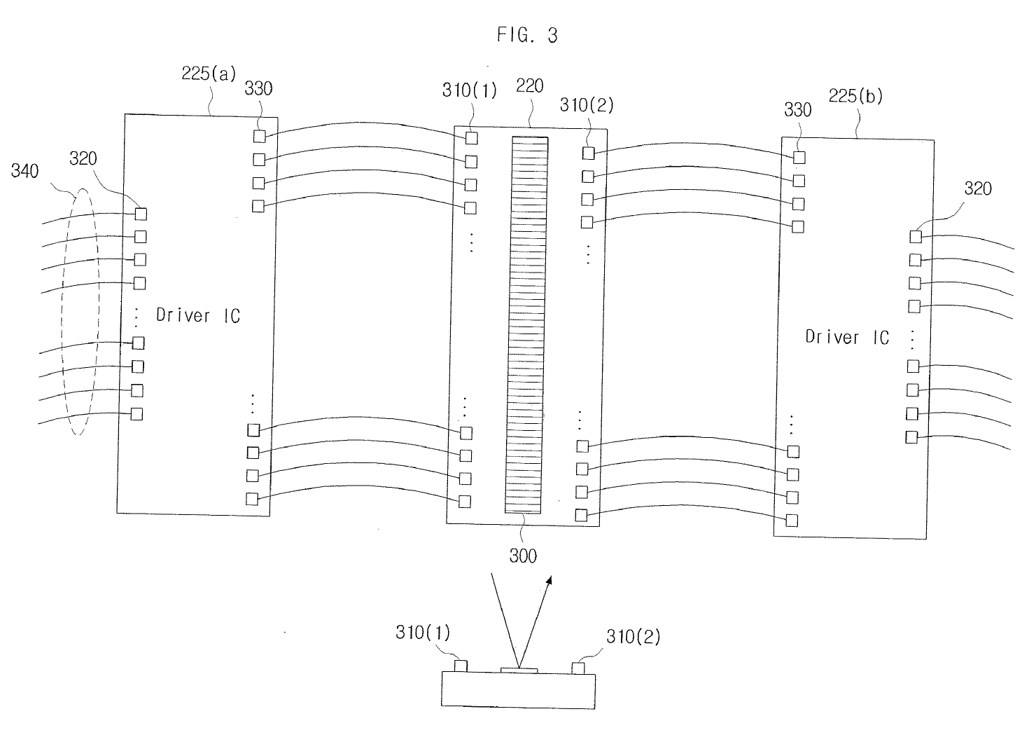

FIG. 3 illustrates a configuration connecting the optical modulator 220 and the driver IC 225 according to an embodiment of the present invention.

The optical modulator 220 includes one or more micromirrors 300 and driving signal input pads 310(1), 310(2), which receives a driving signal for driving the micromirror 300.

And, the image control signal inputted from the image control circuit 250 is transmitted to an input terminal 320 of the drive IC 225(a), 225(b) through a signal input line 340. Here, the image control signal refers to a digital or analog electric signal.

The drive IC 225(a), 225(b) outputs the driving signal, to which the image control signal is converted, through an output terminal 330. Here, the driving signal refers to an individual output signal for each pixel (that is, for each micromirror 300), which allows each micromirror 300 of the optical modulator 220 to display image information, in accordance with the image control signal, onto a pixel corresponding to the micromirror 300. Also, the driving signal can be generated by voltage or current.

The output terminal 330 of the driver IC 225(a), 225(b) has a one to one connection with the driving signal input pad 310(1), 310(2) of the optical modulator 220. Consequently, the individual output signal, namely, the driving signal, for each pixel is supplied independently to the driving signal input pad 310(1), 310(2).

The driving signal input pad 310(1), 310(2) has a one to one connection with the micromirror 300 of the optical modulator 220.

Each micromirror 300 is placed at a position in the range of the displacement having the maximum luminance and the displacement having the minimum luminance by the driving signal, and light inputted to the micromirror 300 is converted by the optical conversion principle described above and is outputted. The outputted light is scanned by the scanner 230 on the screen 240, displaying an image.

In FIG. 3, two driver ICs 225(a), 225(b) are connected to both sides of a single optical modulator 220. But, it is apparent that one driver IC or more than two driver ICs may be connected to an optical modulator 220 to drive each micromirror 300.

However, when an even number of driver ICs are disposed on both sides of the optical modulator 220, driver ICs on one side are connected to every even numbered driving signal input pads and driver ICs on the other side are connected every odd numbered driving signal input pads one after the other so as to enhance a space between connecting lines, thereby facilitating to be manufactured.

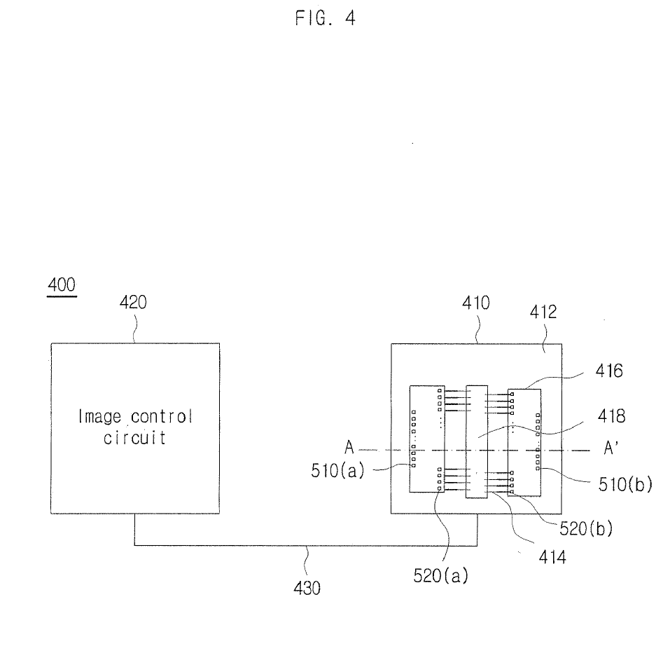

FIG. 4 illustrates a configuration of an device for inspecting the driving performance of an optical modulator according to an embodiment of the present invention.

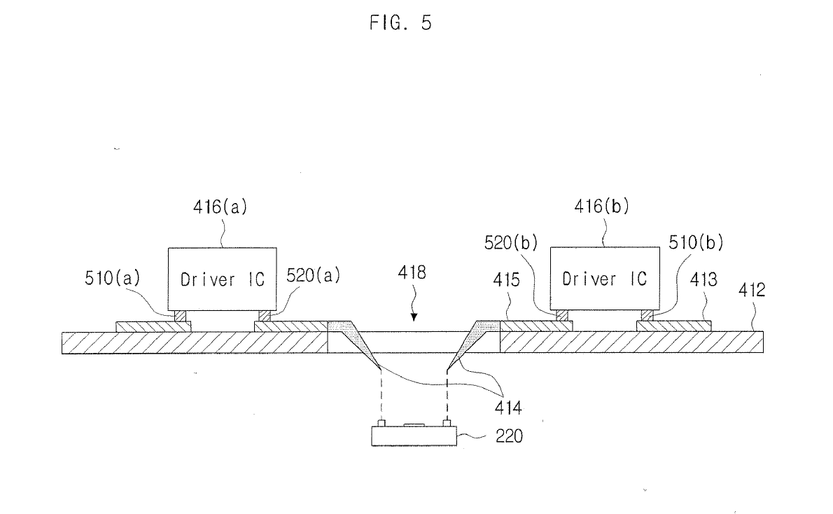

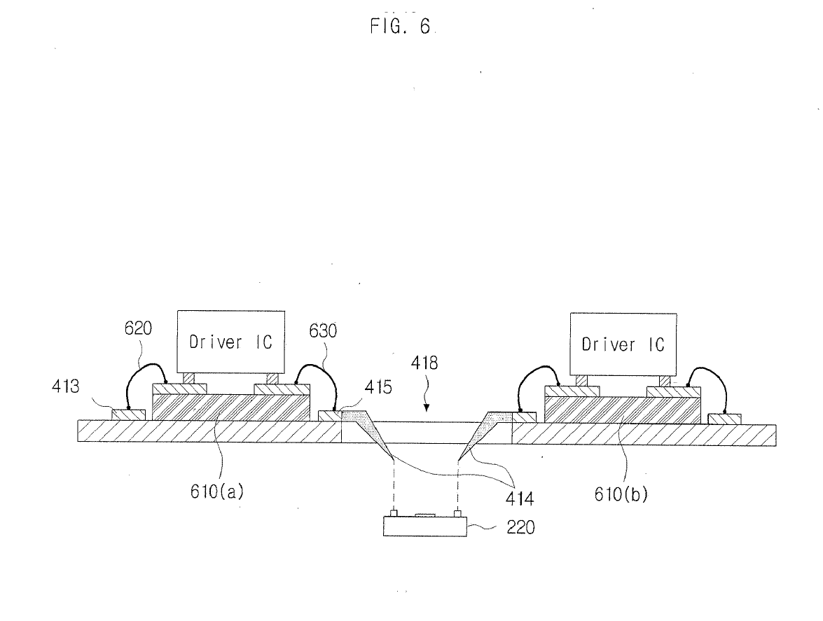

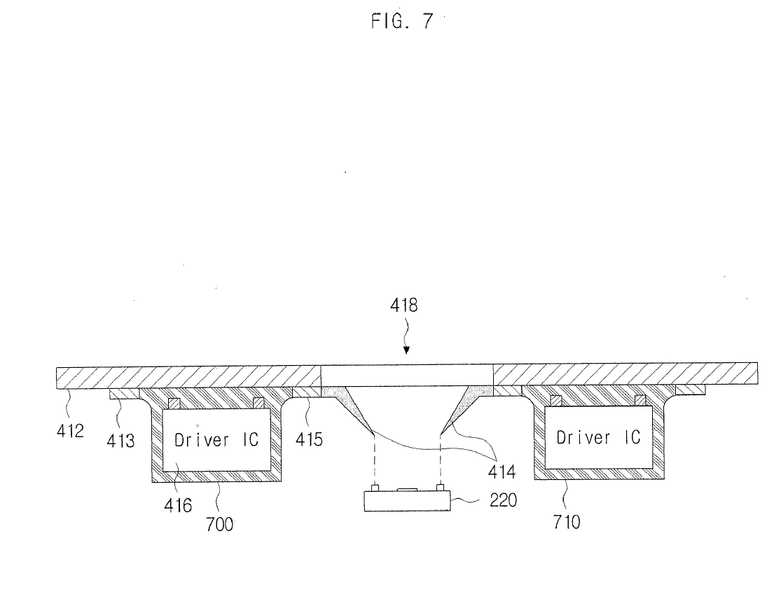

FIG. 5 is a sectional view (AA′ in FIG. 4) of a probe card according to an embodiment of the present invention, FIG. 6 is a sectional view (AA′ in FIG. 4) of a probe card according to another embodiment of the present invention, and FIG. 7 is a sectional view (AA′ in FIG. 4) of a probe card according to another embodiment of the present invention.

Referring to FIG. 4, an optical modulator inspecting device 400 includes a probe card 410 and an image control circuit 420.

The probe card 410 converts a control signal inputted from the image control circuit 420 to a driving signal. Here, the driving signal refers to a voltage or current signal which drives each micromirror of an optical modulator up and down to have a desired displacement. And, the probe card 410 is contacted with a driving signal input pad of the optical modulator to provide the driving signal.

The image control circuit 420 generates a control signal predetermined or designated by an input of a user in order to inspect any malfunction of each micromirror of the optical modulator. And, the image control circuit 420 is electrically connected to the probe card 410 through an electric signal line 430, transmitting the control signal to the probe card 410.

Also, the image control circuit 420 can be implemented by using the image control circuit 250 of the display apparatus in FIG. 2 or by a separate method.

The probe card 410 includes a substrate 412, a probe 414, and a driver integrated circuit (IC) 416.

The substrate 412 is connected to the image control circuit 420 through the electric signal line 430 or a hard board. The substrate 412 can include a connector (not shown) to receive the control signal from the image control circuit 420. And, the substrate 412 may be a printed circuit board (PCB), where a wire is formed so that the electric signal can be transmitted into the internal part and/or the external part. A probe hall 418 is formed in the center of the substrate 412. The probe 414 is attached into the probe hall 418, through which light is inputted to the optical modulator and modulated light is outputted.

Here, the probe hall 418 is desirable to be larger than a set of micromirrors in the optical modulator.

And, the probe hall 418 can be shaped in a rectangular equal or similar to the set of micromirrors of the optical modulator, or in an ellipse or circle.

The driver IC 416 refers to a circuit chip placed on the substrate 412 and connected electrically to it. And, the driver IC 416 converts the control signal to generate and output the driving signal, which can drive each micromirror of the optical modulator.

Also, the driving IC 416 includes the input terminal for receiving the control signal and the output terminal for outputting the driving signal. Here, one or more driving ICs 416 can be implemented, and the control signal is distributed to each driving IC 416 through wires on the substrate 412 in the case of more than one.

Hereinafter, it is assumed that two driving ICs are implemented. But, it is obvious that this assumption does not limit the scope of the invention.

Below is described a method of connecting electrically the driver IC 416 to the substrate 412.

(1) The driver IC 416(a), 416(b) can be electrically connected directly to the substrate 412 (referring to FIG. 5). The electrical connection can be implemented by a flip chip. Input pads 510(a), 510(b) formed on the input terminal and output pads 520(a), 520(b) formed on the output terminal of the driver IC 416(a), 416(b) are connected to a first wire 413 and a second wire 415 on the substrate 412, respectively. The first wire 413 receives and delivers the control signal inputted from the image control circuit 420 to the driver IC 416(a), 416(b). And, the second wire 415 transmits the driving signal outputted from the drive IC 416(a), 416(b) to the probe 414.

(2) The driver IC 416(a), 416(b) is electrically connected directly to a glass or ceramic substrate 610(a), 610(b) in which electric wires are formed, and is wire-bonded to the substrate 610(a), 610(b) by a bonding-wire 620, 630 (referring to FIG. 6). Here, the driver IC 416(a), 416(b) is connected on the glass or ceramic substrate 610(a), 610(b) by a flip chip or chip on glass (COG) method.

Using COG joining, it is possible to implement an ultra thin and extremely light circuit board, and wires of the glass or ceramic substrate 610(a), 610(b) can have a fine connection pitch.

The wires of the glass or ceramic substrate 610(a), 610(b) are connected electrically to the wires 413, 415 of the substrate 412 through the bonding wire 620, 630, using a wire-bonding method.

(3) The driver IC 416(a) 416(b) may be mounted on the substrate 412 by a type of tape carrier package (TCP). The driver IC 416(a), 416(b) is electrically connected to the wire 413, 415, which is formed on the substrate 412, by TCP 700, thereby receiving the control signal and outputting the driving signal.

Besides, the driver IC 416 can be mounted on the substrate 412 by a variety of methods for mounting a chip on a printed circuit board.

One end of the probe 414 is connected to the second wire 415 on the substrate, and the other end of the probe 414 is extended in the direction to a portion where the driving signal input pad of the optical modulator, which is an object for the inspection, is to be located.

When the driving IC 416 is mounted on a side of the substrate 412, the optical modulator 220 that is an object for the inspection is equipped on the side or the other side of the substrate 412.

If the optical modulator 220 is equipped on the other side of the substrate 412 (referring to FIGS. 5 and 6), the other end of the probe 414 passes through the probe hall 418 to be exposed in the other side of the substrate 412.

Whereas, if the optical modulator 220 is equipped on the side of the substrate 412 (referring to FIG. 7), the other end of the probe 414 does not pass through the probe hall 418, but is exposed in the same side of the substrate 412.

The other end of each probe 414 may be smaller than the driving signal input pad in order to prevent contacting with any neighboring driving signal input pad, except for the driving signal input pad corresponding to the probe 414. For example, the other end of the probe 414 can be formed in a top shape of a cone or pyramid.

The number of probes 414 may be as many as the number of the driving signal input pads of the optical modulator. And, the number of the driving signal input pads may be the same as the resolution (m in FIG. 1c) of the one-dimensional image that is projected by the optical modulator.

In case of using two driving ICs, two driving ICs 416 are placed on the both sides of the probe hall 418, and the probes 414 are also disposed alternately in the both sides of the probe hall 418 (for example, every odd numbered probe 414 is disposed in a side of the probe hall 418, and every even numbered probe 414 is disposed in the other side of the probe hall 418) so that a space between probes 414 becomes wider, thereby facilitating to be manufactured.

When inspecting, the probe 414 is connected to the driving signal input pad of the optical modulator 220, and transmits the driving signal from the driver IC 416 to the driving signal input pad. The driving signal, which is inputted through the driving signal input pad, is supplied in voltage to the piezoelectric elements 150 in FIGS. 1a and 1b, and drives the corresponding micromirror up and down, thereby modulating incident light to have expected luminance.

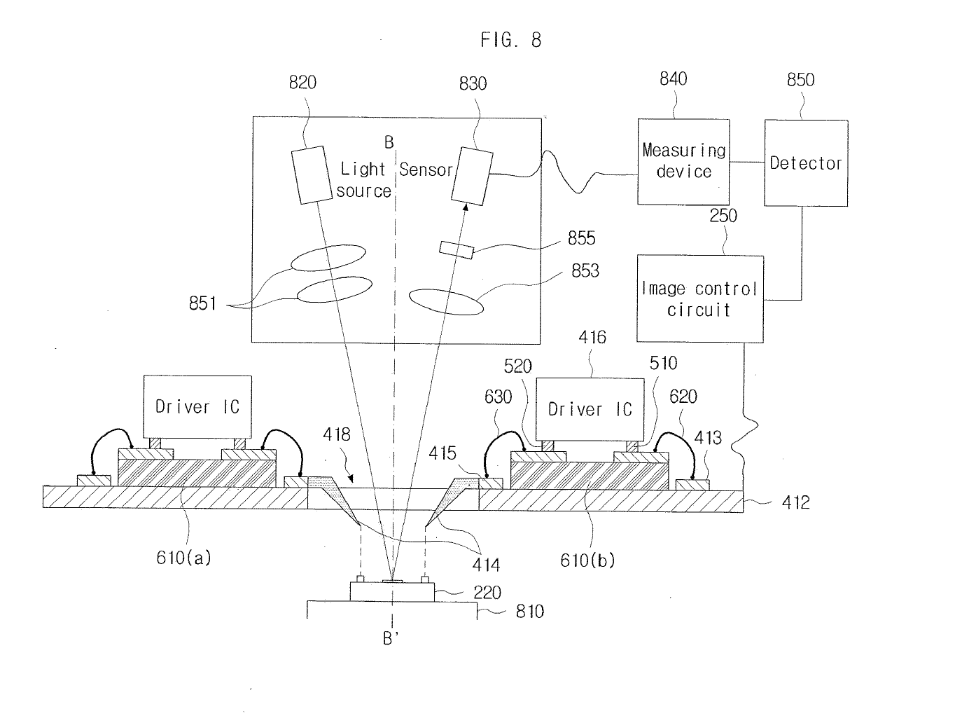

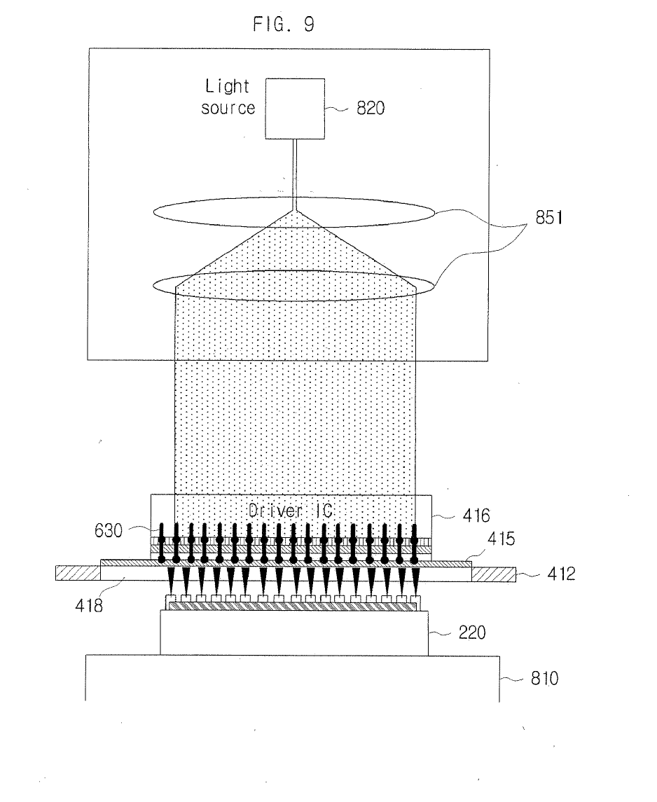

FIG. 8 is a configuration of a device for inspecting an optical modulator 220 according to an embodiment of the present invention, and FIG. 9 is a sectional view of FIG. 8.

The optical modulator inspecting device includes a stage 810, a light source 820, a sensor 830, and a measuring device 840 besides the probe card 410 and the image control circuit 420. The optical modulator inspecting device may further include a slit 855 and/or detector 850.

On the stage 810 is placed a chip type of the optical modulator 220 which is to be inspected. Here, the stage 810 can move horizontally and vertically in the state of horizontality.

The stage 810 having the optical modulator on itself moves horizontally and vertically to arrange the optical modulator 220, so that the driving signal input pad may have a one to one contact with the probe 414.

The light source 820 emits light for determining whether or not the optical modulator 220 is operating properly.

The light source 820 can emit white light or one of the three primary colors, red, green, and blue. The light source 820 can be a laser, a light emitting diode (LED), or a laser diode.

The sensor 830 senses the light which is emitted from the light source 820 to the optical modulator 220, modulated by the optical modulator 220, and outputted. A surface of the sensor 830 is not necessary to be in a plane type in a measurement optical system, but it is enough that the light, which is outputted from the optical modulator 220, is projected within an area where the sensor 830 can sense.

Examples of the sensor 830 can include a segmented photo detector, single photo detector, charge coupled device (CCD), etc.

An optical attenuator can be further equipped at the front of the sensor 830 in order to control the amount of the inputted light.

Since an illumination optical system 851 or projection optical system 853 is identified with the illumination optical system 215 or projection optical system illustrated in FIG. 2, detailed description about that is omitted here.

The slit 855 allows only diffracted light of the designated order among the light modulated by the optical modulator 220 to be inputted to the sensor 830. The light modulated by the optical modulator 220 can be the 0-order diffracted light, +1 order diffracted light, or −1 order diffracted light, etc. Among them, the diffracted light of only the desired order can be passed through the slit 855.

The measuring device 840 measures a luminance of the light detected by the sensor 830.

The detector 850 is connected with the image control circuit 250, receives the control signal provided from the image control circuit 250 to the probe card 410, or luminance information corresponding to the control signal. The luminance information corresponding to the control signal can be called an ideal luminance.

The detector 850 compares the ideal luminance with the luminance measured by the measuring device 840. If the difference between luminance measured by the measuring device 840 and the ideal luminance is within an appropriate range, it is determined that the optical modulator 220 is operating properly. Whereas, if the difference between the measured luminance and the ideal luminance exceeds the appropriate range, it is determined that the optical modulator 220 is operating malfunctionally.

Here, the appropriate range can be predetermined or designated by a user.

Also, the measuring device 840 can measure separately a luminance for each micromirror of the optical modulator 220. Therefore, the detector 850 can compare the ideal luminance corresponding to the control signal with the luminance that is measured for each micromirror, and then determine whether or not each micromirror is operating properly.

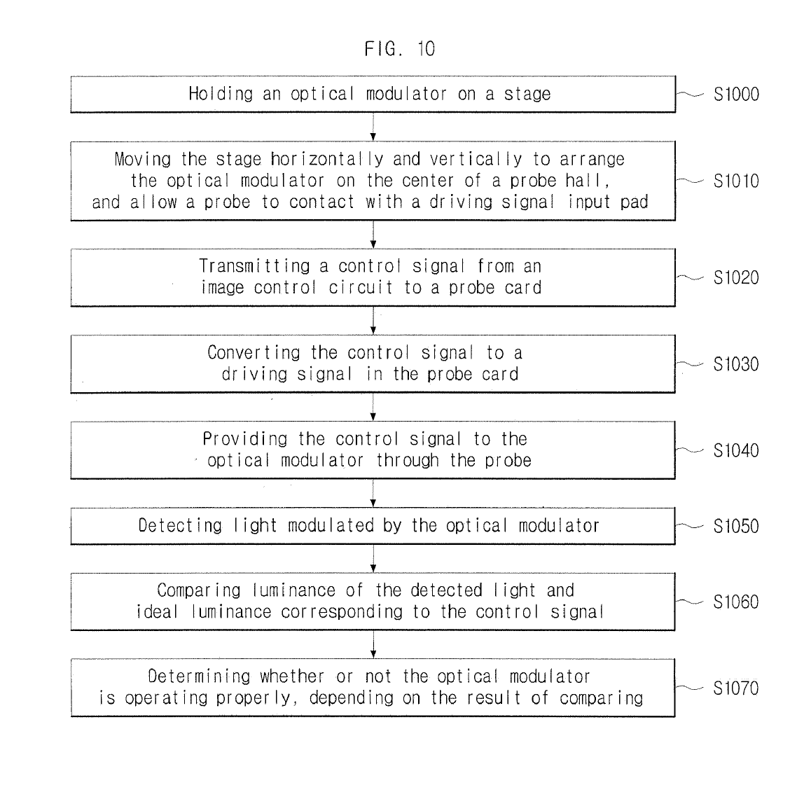

FIG. 10 is a flowchart of a method for inspecting the optical modulator according to an embodiment of the present invention.

At the step S1000, the optical modulator 220 is kept on the stage 810.

At the step S1010, the stage 810 is moved in the predetermined order or in the input order by a user, so that the optical modulator 220 is arranged at the center of the probe hall 418, and the probe 414 is contacted with the driving signal input pad of the optical modulator 220.

The stage 810 can be moved vertically in order to have an appropriate gap with the optical modulator 220. Or, it is also possible that the probe card 410 is moved instead of the stage 810.

At the step 1020, the image control circuit 250 transmits the control signal, which is predetermined or inputted by a user, to the probe card 410 in order to determine whether or not the optical modulator 220 is operating properly.

At the step S1030, the driver IC 416 of the probe card 410 converts the control signal to the driving signal. And, the driving signal is provided to the optical modulator 220 through the probe 414 at the step S1040.

In addition, after the drive signal is provided to the optical modulator 220, the sensor 830 detects the light modulated by the optical modulator 220 at the step S1050.

At the step S1060, the luminance of the sensed light is compared with the ideal luminance corresponding to the control signal.

At the step S1070, the status of the optical modulator 220 is determined depending on the result of the step S1060. For example, if the difference between the sensed luminance and the ideal luminance is within the predetermined range, then it is determined that the optical modulator 220 is operating properly. To the contrary, if the difference is out of the predetermined range, it is determined that the optical modulator 220 is operating malfunctionally.

The process of determining the operation of the optical modulator 220 in the step S1070 can be performed separately for each micromirror of the optical modulator 220.

Also, at the step S1050, the sensor 830 can detect only diffracted light of the predetermined order or designated order by a user in the light modulated by the optical modulator 220.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A device for inspecting an optical modulator, the device comprising:
a probe card that converts an inputted control signal to a driving signal, and provide the driving signal by contacting with each driving signal input pad of an optical modulator—wherein the optical modulator comprises one or more micromirrors and one or more driving signal input pads connected to the micromirrors, respectively, and the micromirror moves up and down according to the driving signal inputted through the driving signal input pad—; and
an image control circuit that generates the control signal for checking if the optical modulator is operation properly, and is connected electrically to the probe card to transmit the control signal.

2. The device of claim 1, wherein the probe card comprises:
a substrate where a probe hall, a first wire through which the control signal is transmitted, and a second wire through which the driving signal is transmitted are formed;
a driver IC that is connected electrically to the first and the second wires, converts the control signal, which is inputted through the first wire, to the driving signal, and then outputs the driving signal through the second wire; and
one or more probes of which one end is connected electrically to the second wire and fixed on the substrate, and the other end is extended in the direction where the optical modulator will be located, so that the probe can be contacted with the driving signal input pad,
wherein the number of the probe is the same as that of the driving signal input pad.

3. The device of claim 2, wherein if the driver IC is formed on one side of the substrate and the optical modulator is formed on the other side, the other end of the probe is exposed to the other side of the substrate through the probe hall.

4. The device of claim 2 further comprising:
a light source that irradiates light to the optical modulator;
a stage that supports the optical modulator such that the light is irradiated onto the micromirror;
a sensor that detects light modulated and outputted by the optical modulator; and
a measuring device that measures luminance of the light detected by the sensor.

5. The device of claim 4 further comprising a slit that allows only diffracted light of a predetermined-order in the light modulated and outputted by the optical modulator to pass and be inputted to the sensor.

6. The device of claim 4, wherein the stage can move horizontally and vertically, and let the optical modulator be arranged on the center of the probe hall such that the probe is contacted with the driving signal input pad.

7. The device of claim 4, wherein the probe card can move horizontally and vertically, and let the optical modulator be arranged on the center of the probe hall such that the probe is contacted with the driving signal input pad.

8. The device of claim 4 further comprising a detector that determines whether or not the optical modulator is operating properly by comparing luminance of the light measured by the measuring device and ideal luminance corresponding to the control signal of the image control circuit.

9. The device of claim 8, wherein the detector determines whether or not each micromirror of the optical modulator is operating properly

10. A method for inspecting an optical modulator, the method comprising:
holding an optical modulator on a stage;
moving the stage horizontally and vertically to arrange the optical modulator on the center of a probe hall, and allow a probe to contact with a driving signal input pad;
transmitting a control signal from an image control circuit to the probe card;
converting the control signal to a driving signal in the probe card; and
providing the control signal to the optical modulator through the probe.

11. The method of claim 10 further comprising:
detecting light modulated by the optical modulator;
comparing luminance of the detected light and ideal luminance corresponding to the control signal; and
determining whether or not the optical modulator is operating properly, depending on the result of comparing.

12. The method of claim 11, wherein the determination is performed separately for each micromirror of the optical modulator.

13. The method of claim 11, wherein the detecting of light is a detection only of diffracted light of a predetermined-order in the light modulated by the optical modulator.
